(19) United States
(12) Patent Application Publication
(10) Pub. No.: US 2009/0184038 A1
(43) Pub. Date: Jul. 23, 2009

(54) SYSTEM AND METHOD FOR REMOVING PARTICLES FROM A TREATMENT BASIN

(76) Inventors: Michael Graham, Bountiful, UT (US); Kraig Johnson, South Jordan, UT (US)

Correspondence Address: THORPE NORTH & WESTERN, LLP., P.O. Box 1219, SANDY, UT, 84091-1219, US

(21) Appl. No.: 12/355,636

(22) Filed: Jan. 16, 2009

Related U.S. Application Data
(60) Provisional application No. 61/021,367, filed on Jan. 16, 2008.

(51) Int. Cl. B01D 24/28

(52) U.S. Cl. 210/189

(57) ABSTRACT

A system and method are provided for removing particulates from a fluid treatment basin. The system can include a first continuously inclined surface configured to be substantially submerged in fluid in the fluid treatment basin. A base can be provided to which the first continuously inclined surface is connected. At least one orifice is formed in the base. In addition, a second continuously inclined surface can be connected to the base on a side opposing the first continuously inclined surface. The second continuously inclined surface may be substantially submerged in fluid in the fluid treatment basin. A discharge conduit can be connected to the orifice in order to discharge fluid and particulates gathered via the orifice.

### PRIORITY CLAIM

Priority of U.S. Provisional patent application Ser. No. 61/021,367 filed on Jan. 16, 2008 is claimed, which is hereby incorporated herein by reference in its entirety.

### FIELD OF THE INVENTION

The present invention relates generally to water treatment.

### BACKGROUND

Sedimentation basins are a widespread water treatment technology in developed countries. Sedimentation basins can be used to treat incoming clean water for drinking or to treat waste water in secondary clarifiers when waste water is being prepared to be released from a waste treatment plant.

Sedimentation basins remove very fine particles from water using gravity. The water containing solids enters the basin at one side and the cleaner water is taken out from another side typically over an outlet weir. The water is generally stored in the basin long enough for the desired particle size to be removed. Smaller particles require longer periods for removal and usually use larger basins. Sometimes a flocculant may be added to help smaller particles stick together and form larger particles. Stoke's Law can also be used to calculate the size of a settling basin needed in order to remove a desired particle size. Other names for sedimentation basins may be: settling basins, settling ponds or decant ponds.

Once the particles have settled to the bottom of a basin, the solid particles can then be removed using various machines with moving parts. Several types of sludge collectors have been used in the past to perform this task. One type of sludge collector is a pneumatically driven vacuum collector that removes solids from sedimentation basins by means of suction generated through a differential head or pumping. The pneumatic vacuum collector head is moved across the basin floor using cables or mechanical drives in order to collect up the particles.

Another type of extraction device uses a series of scrapers that scrape the sediment or particles across the basin floor. The particles are moved by the scraping blades until the particles arrive at a point where the particles can be removed from the basin.

The goal of such particle extractors is to enable quick, convenient particle removal without draining the basin. However, these types of devices are subject to wear and breakage due to the large number of moving parts, and then the entire basin is generally drained to fix the extraction assembly.

### BRIEF DESCRIPTION OF THE DRAWINGS

FIG. 1 is a perspective view of a system for removing particulates from a fluid treatment basin in accordance with one embodiment;

FIG. 2 is a top view of the system for removing particulates from a fluid treatment basin as in FIG. 1;

FIG. 3 is a cross-section view of the system for removing particulates from a fluid treatment basin as in FIG. 1;

FIG. 4a is a cross-section view that illustrates an embodiment of a system for removing particulates with more steeply inclined walls and a tubular channel;

FIG. 4b is a cross-section view that illustrates an embodiment of a system for removing particulates with hemispherical walls and a tubular channel;

FIG. 5 is a cross-section view that illustrates an embodiment of a system for removing particulates with a single inclined surface, a horizontal surface, and a slot shaped rectangular channel;

FIG. 6 is a top view of a system for removing particulates that illustrates a divided cell embodiment; and

FIG. 7 is a flow chart illustrating a method for removing particulates from a fluid treatment basin.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As used herein, the terms “incline” or “inclined” refer to an angle greater than a zero degree angle. For example, a “continuously inclined surface” would be one that may include a surface oriented at any angle other than a horizontal or zero degree angle.

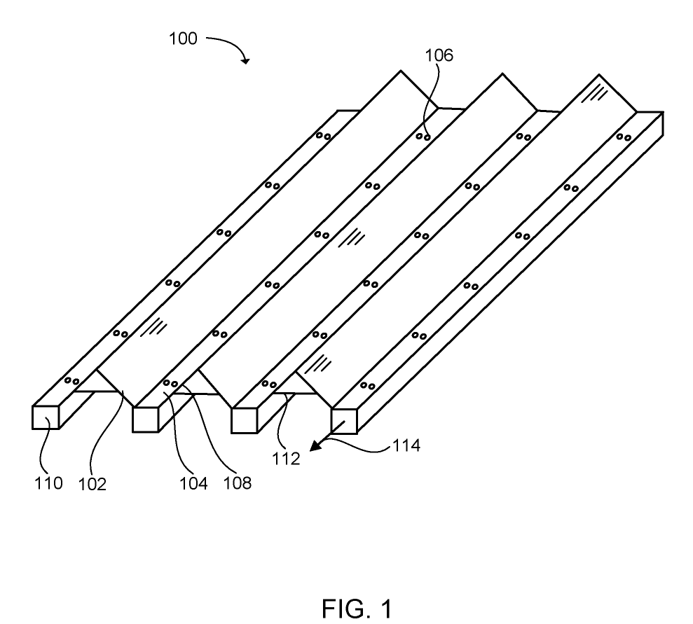

A perspective view of a system 100 for removing particulates or solids from a fluid treatment basin is illustrated in FIG. 1. The system can include a first continuously inclined surface 102 configured to be substantially submerged in fluid in the fluid treatment basin. A base 104 or connection piece can also be provided to which the first continuously inclined surface is connected. One or more orifices 106 can also be formed that pass through the base and enable fluid and particulates to pass through the base.

A second continuously inclined surface 108 can be connected to the base 104 on a side opposing the first continuously inclined surface. The second continuously inclined surface is also substantially submerged in the fluid in the treatment basin. The inclined surfaces may have a planar surface oriented at a non-vertical angle in order to guide particles toward the orifice. However, the inclined surfaces can be spherical, partially spherical, or use other surface shapes that have a continuous incline for guiding the particles. It is noted also that the inclined surfaces may be formed integrally with the base or formed independently of the base and subsequently be attached to the base.

In one implementation, the first and second continuously inclined surfaces are disposed in a water sedimentation basin. For example, the inclined surface can be anchored to the bottom of the water sedimentation basin. The water can enter from one side of the basin and then the water can move slowly through the basin so that the sediment can precipitate from the water using gravity and possibly a flocculant. An example of a flocculent may be alum or ferric chloride. Then the cleaner water can exit from another side of the basin using a surface outlet weir for further processing and use as drinking water. As the particles and sediment fall towards the bottom of the basin, the solids are caught by the continuously inclined surfaces and directed toward the orifices.

The inclined surfaces or any other portions of the system can be covered with a surface coating to enable the particulates to more easily travel down and across the surfaces. For example, the surfaces can be covered with plastics, non-stick materials, specialized metal coatings or other coatings that aid in the collection of the particulates.

A discharge conduit 110, as in FIG. 1, can be connected to one or more orifices in order to discharge fluid and particulates 114 gathered via the orifice. The discharge conduit can also have a valve that is coupled to the end of the discharge piping. The valve may be closed for a time period and when enough particulate matter has been collected or enough time has passed, then the valve can be opened to enable the particulates, sediment, and a small amount of water to pass through the orifices and out of the discharge conduit.

The particulates in the water may only be a small percentage (e.g., 1/10% to 6%) or more of the removed fluid by weight. The valve timing for removal of the particulates can be controlled so that pre-determined ratios of water and particulates are removed from the system. In other words, the system can remove a specific amount of water with the particulates by timing the valves so that a defined ratio of particulates and water are collected.

The valves can be opened and closed by using electrical controls such as solenoid controlled valves, motor controlled valves or other types of automated valves. The valve systems may also be controlled by timers or more comprehensive water management control software. Alternatively, the valves can be opened and closed using manual methods.

The disclosed system can also use an underlying frame 112 (FIG. 1), cross supports, and other structural framework that can be used for supporting a plurality of inclined surfaces in the fluid treatment basin.

Sensors may be included in each trough, cell or holding area to measure the amount of particulates that have built up. Once the sensor threshold has been reached then the valves can be opened and the particulates can be removed through the discharge conduits. Examples of sensors that might be used include infrared sensors, LED sensors, clarity or turbidity sensors, optical sensors, mechanical sensors and other sensors that can sense when the particulates are filling a certain portion of the holding area. In other words, the sensors can measure the depth or density of particle buildup near the orifices. An optical sensor can also be located at the removal points or near discharge valves to sense when particulates have been removed.

The systems and methods described herein effectively remove sediment from the bottom of a sedimentation basin without using mechanical scraping or the mechanized removal systems that have been used in the past. In other words, this combination of elements forms a sedimentation bed or “Sed Bed” that enables particle removal using water pressure or negative pressure. Because the moving parts that are used in the described embodiments can be located outside of the basin (e.g., valves and pumps), this makes the overall system easier to maintain and fix. The main moving parts of the disclosed embodiments are in the valve systems which can be located outside of the basin. In the past, mechanical systems with moving parts have been submerged in the bottom of the basin to remove sediment and particulates. When these mechanical systems wear out, then the basins need to be drained for the mechanical systems to be fixed. The draining of the system is very time consuming and removes an entire basin from the water production system for a period of time. The present system and method is more likely to avoid draining sedimentation basins when repairs are needed.

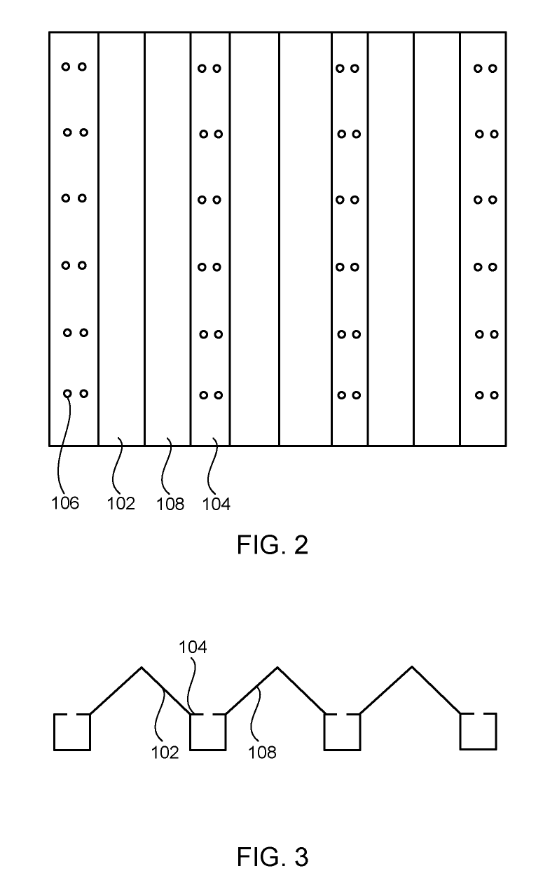

FIG. 2 illustrates a top view of the system of FIG. 1 for removing particulates from a fluid treatment basin. While FIG. 2 is illustrated as having a square perimeter, the system perimeter can be any shape that is configured to match the shape of the basin being used. FIG. 3 illustrates a side view of the system of FIG. 1 for removing particulates.

In another embodiment, a negative pressure system can be coupled to the discharge conduits or piping to draw particulates and fluid through the orifice using negative pressure. Using a negative pressure or vacuum system is valuable because it can reduce the amount of time it takes to remove particulates from around the orifices and through the discharge conduits. A negative pressure system may even create a current which can sweep even more of the particulates and sediments from the basin than might otherwise be collected using only water pressure. The negative pressure system can use a pump or differential head to remove the solids and fluid.

The system and method has been described as being used for water sedimentation, but the system can also be used for waste water treatment. For example, this system may be used in secondary waste clarifiers. Larger orifices and discharge conduits may be used to remove biological sediments from waste water treatment systems but the same collection structures and methods described above apply.

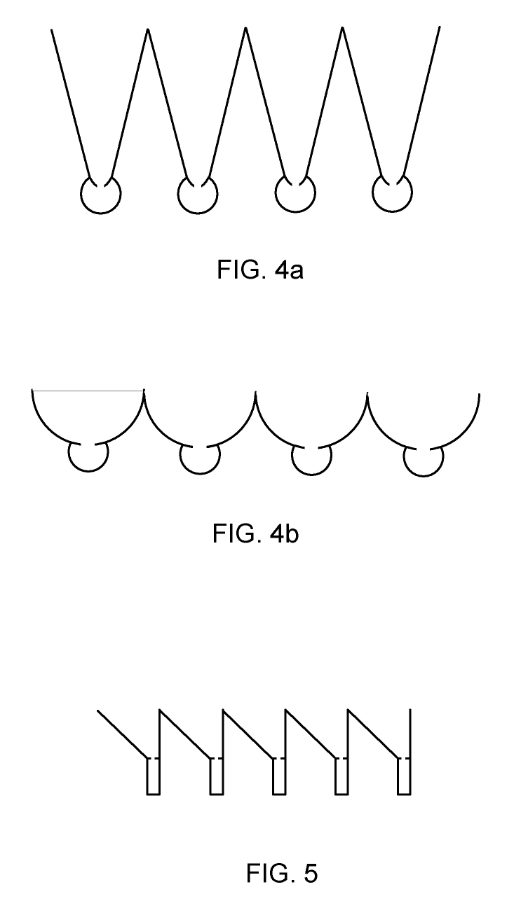

FIG. 4a illustrates an embodiment of the system that has inclined surfaces with a greater amount of gradient. The discharge conduit can also be attached to the inclined surface in such a way that the discharge conduit supports the inclined surfaces. In addition, the orifices may be formed using the lower portion inclined surfaces. This can avoid the need for forming a separate base in the manufacturing process. FIG. 4b illustrates an embodiment of a system for removing particulates with hemispherical walls and a tubular channel;

FIG. 5 illustrates an embodiment of the system for removing particulates from a fluid treatment basin that uses only one substantially inclined surface. The second surface illustrated in FIG. 5 can be vertical or nearly vertical. In one configuration, the orifices can be nearer to the inclined wall than to vertical wall in order to more effectively collect particulates.

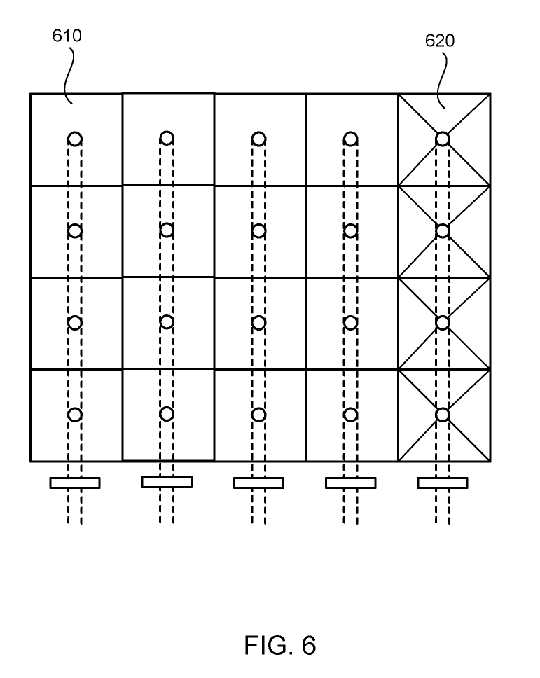

FIG. 6 is a top view of the system for removing particulates that illustrates a divided cell embodiment. Instead of having long troughs as illustrated previously, the collection areas can be divided into multiple inclined or sloped areas (e.g., funnels) that guide the particulates down to the removal orifice. The sloped areas may be a substantially smooth inverted cone 610, an inverted pyramidal shape 620, or an inverted hemisphere. Each cell may have a round perimeter or have three, four, five, six or even more sides depending on the desired configuration.

The sloped areas may also be a regular (non-inverted) cone, pyramidal shape or hemisphere. Such a configuration may require the discharge orifices and pipes to be formed in a general grid pattern to effectively collect particulates around such shapes. In one embodiment, the pipes may also form an interlocking grid pattern using 4-way pipe interchanges. Alternatively, it may be useful to provide discharge pipes at varying depths that do not interlock and/or to discharge the discharge pipes in differing directions (e.g. a different direction for each grid row orientation) to effectively utilize such shapes. Any variety of shapes that provides the desired inclines, whether inverted and upright, may be utilized as would be apparent to one having skill in the art.

The actual shape of the cells and troughs used to capture and guide the particulates to the orifices can vary widely as needed by the specific application. The size and geometry of the orifices may vary, and the discharge conduit can be any geometric shape or configuration that is useful for transporting the fluid and particulates away from the orifices. In addition, the size of each cell or trough and the respective orifices, slots, or openings may be small and on the order of centimeters, or each cell may be larger and on the order of one or two meters. The sizing of the structure used here to capture particulates can vary widely depending on the application of the system.

Another result of the present system is that shallower walls may be used in sedimentation basins. This is because the sedimentation basin does not need to be as deep as previously needed to house the complex mechanical system previously used in basins. Since this system does not use complex moving parts in the basin, then somewhat shallower walls can be used. Shorter basin walls result in a basin that is cheaper to build and avoids possible problems with local water tables.

The system and method described may also include an air or fluid back wash system to remove clogs or to clean the system. The backwash system can be activated at timed intervals or activated manually when a problem occurs.

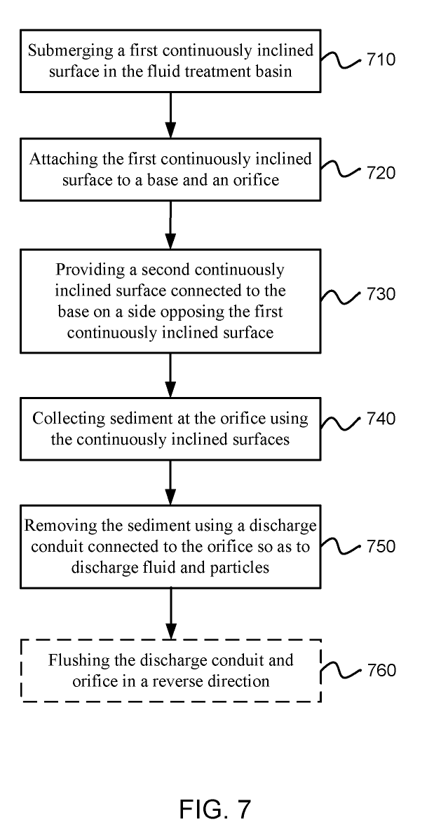

FIG. 7 illustrates a method for removing particulates from a fluid treatment basin. The method can include the operation of submerging a first continuously inclined surface in the fluid treatment basin 710. Another operation is attaching the first continuously inclined surface to a base and at least one orifice formed in the base 720.

A second continuously inclined surface can be provided and connected to the base on a side opposing the first continuously inclined surface in the fluid treatment basin 730. The sediment can be collected at or through the at least one orifice using the continuously inclined surfaces 740. Then the sediment can be removed using a discharge conduit configured to be connected to the orifice in order to discharge fluid and particles gathered via the orifice 750. An optional operation is to flush the discharge conduit and orifice in a reverse direction after the particulates have been removed 760. The flushing in the reverse direction may be with water or air.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A system for removing particulates from a fluid treatment basin, comprising:
a first continuously inclined surface configured to be at least partially submerged in fluid in the fluid treatment basin;
a base to which the first continuously inclined surface is connected;
at least one orifice formed in the base;
a second continuously inclined surface connected to the base on a side opposing the first continuously inclined surface, the second continuously inclined surface being configured to be at least partially submerged in fluid in the fluid treatment basin; and
a discharge conduit connected to the at least one orifice in order to discharge fluid and particulates gathered via the orifice.

2. A system in accordance with claim 1, wherein the first continuously inclined surface comprises a planar surface aligned at a non-vertical angle so as to guide particulates toward the orifice.

3. A system in accordance with claim 1, further comprising a negative pressure system, couplable to the discharge conduit to draw particulates and fluid through the orifice using negative pressure.

4. A system in accordance with claim 1, further comprising a valve coupled to the discharge conduit.

5. A system in accordance with claim 4, wherein the valve can be opened and closed using at least one of electrical, motor, and manual controls.

6. A system in accordance with claim 1, further comprising a frame, configured to support a plurality of inclined surfaces in the fluid treatment basin.

7. A system in accordance with claim 1, wherein the fluid is water.

8. A system in accordance with claim 1, wherein the first and second continuously inclined surfaces are disposed in a water sedimentation basin.

9. A system in accordance with claim 1, further comprising sensors in a holding area for sensing at least one of particulate density, particulate depth, and particulate to water ratio.

10. A system in accordance with claim 1, wherein at least one of the first and second continuously inclined surfaces comprises a non-planar surface configured to guide particulates toward the orifice.

11. A system in accordance with claim 1, further comprising a discharge system configured to automatically discharge the fluid and particulates when particulate amounts reach a predetermined level.

12. A system in accordance with claim 11, wherein the discharge system is configured to automatically stop discharging fluid and particulates when particulate amounts have fallen below a predetermined level.

13. A system in accordance with claim 1, wherein at least one of the first and second continuously inclined surfaces further comprises a surface coating configured to minimize particulate accumulation.

14. A system in accordance with claim 1, further comprising a reverse flushing system for flushing the discharge conduit and orifice in a reverse direction.

15. A system in accordance with claim 1, further comprising a plurality of systems for removing particulates from a fluid treatment basin, wherein an upper edge of a second continuously inclined surface of a first system is adjacent an upper edge of a first continuously inclined surface of a second system to prevent particulates from passing between the systems.

16. A method for removing particulates from a fluid treatment basin, comprising:
providing a base in the fluid treatment basin, the base having at least one orifice formed therein;
providing a first continuously inclined surface in the fluid treatment basin and connected to the base;
providing a second continuously inclined surface in the fluid treatment basin and connected to the base on a side opposing the first continuously inclined surface;
collecting sediment at the at least one orifice using the continuously inclined surfaces; and
removing the sediment using a discharge conduit configured to be connected to the orifice so as to discharge fluid and particulates gathered via the orifice.

17. A method as in claim 16, further comprising the step of flushing the discharge conduit and orifice in a reverse direction.

18. A method as in claim 16, further comprising the step of using sensors in a holding area to sense at least one of particulate density, particulate depth, and particulate to water ratio.

19. A system for removing particulates from a fluid treatment basin, comprising:
a continuously inclined surface configured to be substantially submerged in fluid in the fluid treatment basin;
a base to which the first continuously inclined surface is connected;
at least one orifice formed in the base; and
a discharge conduit configured to be connected to the at least one orifice in order to discharge fluid and particulates gathered via the orifice.

20. A system as in claim 19, further comprising a second surface connected to the base on a side opposing the continuously inclined surface, the second surface being substantially submerged in fluid in the fluid treatment basin.
